(19) United States
(12) Patent Application Publication
(10) Pub. No.: US 2018/0096750 A1
(43) Pub. Date: Apr. 5, 2018

(54) COMPOSITE TWISTED WIRE CONDUCTOR AND INSULATED WIRE PROVIDED WITH SAME

(71) Applicant: YAZAKI CORPORATION, Tokyo (JP)

(72) Inventor: Hiroyuki MASUI, Susono-shi (JP)

(73) Assignee: YAZAKI CORPORATION, Tokyo (JP)

(21) Appl. No.: 15/671,389

(22) Filed: Aug. 8, 2017

(30) Foreign Application Priority Data
Oct. 5, 2016 (JP) 2016-196829

(51) Int. Cl. H01B 5/08; H01B 7/00

(52) U.S. Cl. CPC H01B 5/08; H01B 7/0009

(57) ABSTRACT

A composite twisted wire conductor has a plurality of aggregated twisted wires formed by primarily twisting a plurality of conductive metal strands. The conductor includes a center aggregated twisted wire which is an aggregated twisted wire positioned on the most center side of a section, a first layer composite twisted wire formed by mainly twisting a plurality of aggregated twisted wires provided to overlap the periphery of the center aggregated twisted wire, and a second layer composite twisted wire formed by mainly twisting a plurality of aggregated twisted wires provided to overlap the periphery of the first layer composite twisted wire. The center aggregated twisted wire is primarily twisted in a first direction. The first layer composite twisted wire is primarily and mainly twisted in a second direction opposite to the first direction. The second layer composite twisted wire is primarily and mainly twisted in the first direction.

### CROSS REFERENCE TO RELATED APPLICATIONS

This application is based on Japanese Patent Application (No. 2016-196829) filed on Oct. 5, 2016, the contents of which are incorporated herein by way of reference.

### BACKGROUND

The present invention relates to a composite twisted wire conductor and an insulated wire provided with the same.

In the related art, a composite twisted wire conductor in which a plurality of intertwined strands are used as an aggregated twisted wire and a composite twisted wire made by intertwining a plurality of aggregated twisted wires is used as a conductor portion, is suggested (for example, refer to Patent Document 1). The composite twisted wire conductor described in Patent Document 1 is configured of a center aggregated twisted wire disposed at the center, a first layer aggregated twisted wire disposed in the periphery thereof, and a second layer aggregated twisted wire in the periphery thereof, and all of a twisting direction (primary twisting direction) of the first and second layer aggregated twisted wires, a twisting direction (main twisting direction) of a first layer composite twisted wire made by twisting the plurality of first layer aggregated twisted wires, and a twisting direction (main twisting direction) of a second layer composite twisted wire made by twisting the plurality of second layer aggregated twisted wires, are the same direction.

### [Patent Document 1] JP 2006-156346 A

### SUMMARY

Considering the problem of the related art, an object of the present invention is to provide a composite twisted wire conductor which improves flatness and is likely to ensure the minimum thickness, and an insulated wire provided with the same.

According to one advantageous aspect of the invention, there is provided a composite twisted wire conductor having a plurality of aggregated twisted wires formed by primarily twisting a plurality of conductive metal strands, the conductor including:

a center aggregated twisted wire which is an aggregated twisted wire positioned on the most center side of a section;

a first layer composite twisted wire formed by mainly twisting a plurality of aggregated twisted wires provided to overlap a periphery of the center aggregated twisted wire; and

a second layer composite twisted wire formed by mainly twisting a plurality of aggregated twisted wires provided to overlap a periphery of the first layer composite twisted wire,

wherein the center aggregated twisted wire is primarily twisted in a first direction,

wherein the first layer composite twisted wire is primarily and mainly twisted in a second direction opposite to the first direction, and

wherein the second layer composite twisted wire is primarily and mainly twisted in the first direction.

A primary twisting pitch of the aggregated twisted wire that configures the first layer composite twisted wire may be greater than a primary twisting pitch of the aggregated twisted wire that configures the second layer composite twisted wire.

the primary twisting pitches of the aggregated twisted wires that configure the center aggregated twisted wire and the second layer composite twisted wire may be substantially the same as each other.

According to another advantageous aspect of the invention, there is provided an insulated wire including:

the composite twisted wire conductor according to the above; and

an insulating coating portion provided in the composite twisted wire conductor.

### BRIEF DESCRIPTION OF DRAWINGS

FIG. 1 is a perspective view illustrating an example of an insulated wire including a composite twisted wire conductor according to the embodiment of the invention.

FIGS. 2A and 2B are sectional views schematically illustrating the composite twisted wire conductor illustrated in FIG. 1. FIG. 2A illustrates a first example, and FIG. 2B illustrates a second example.

FIGS. 3A and 3B are views illustrating a section of an insulated wire. FIG. 3A illustrates a section of the insulated wire when all of the twisting directions are the same direction, and FIG. 3B illustrates a section of the insulated wire according to the first example illustrated in FIGS. 2A and 2B.

### DETAILED DESCRIPTION OF EXEMPLIFIED EMBODIMENTS

In the composite twisted wire conductor described in Patent Document 1, since a three-layered structure including the center aggregated twisted wire, the first layer composite twisted wire, and the second layer composite twisted wire, is employed, and all of the twisting directions are the same direction as described above, the strand is likely to enter between the strands on the other layers, the flat shape of the conductor after the intertwining becomes raised (flatness deteriorates), and the shape is likely to become an elliptical shape in a sectional view. In addition, when performing coating processing on the conductor of which the section has an elliptical shape, unevenness is generated in coating thickness, and it becomes difficult to ensure the minimum thickness of a product.

Considering the problem of the related art, an object of the present invention is to provide a composite twisted wire conductor which improves flatness and is likely to ensure the minimum thickness, and an insulated wire provided with the same.

Hereinafter, an appropriate embodiment of the present invention will be described based on the drawings, but the present invention is not limited to the following embodiment.

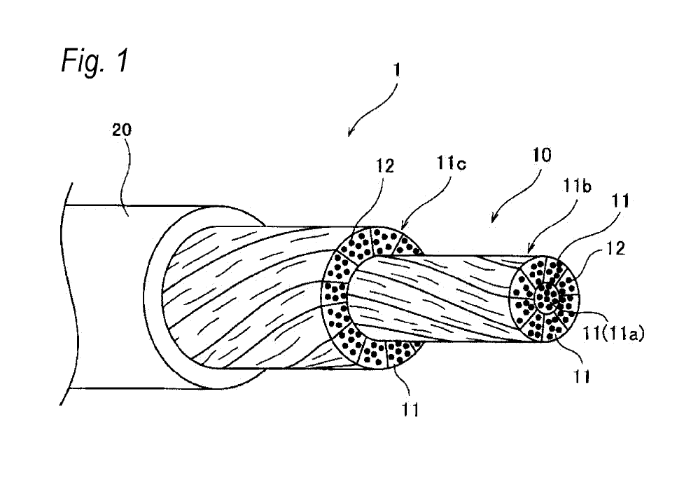

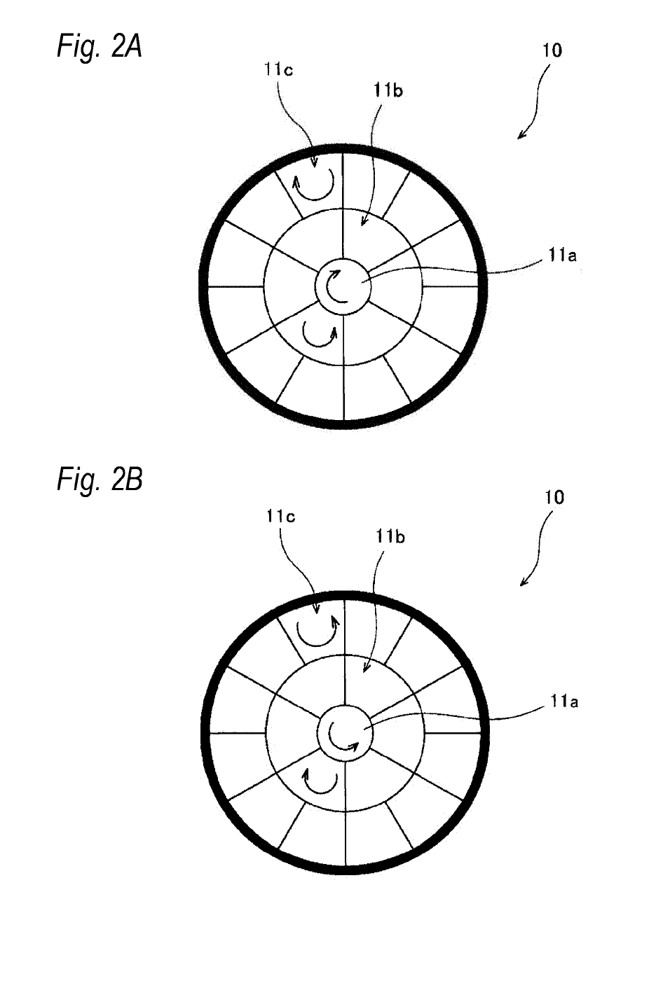

FIG. 1 is a perspective view illustrating an example of an insulated wire including a composite twisted wire conductor according to the embodiment of the invention. FIGS. 2A and 2B are sectional views schematically illustrating the composite twisted wire conductor illustrated in FIG. 1. FIG. 2A illustrates a first example, and FIG. 2B illustrates a second example. As illustrated in FIG. 1, the insulated wire is configured of a composite twisted wire conductor 10 and an insulating coating portion 20 provided on the composite twisted wire conductor 10.

The composite twisted wire conductor 10 is configured to include a plurality of aggregated twisted wires 11 formed by primarily twisting a plurality of conductive metal strands 12. Here, the aggregated twisted wire 11 in the embodiment is configured by intertwining 19 metal strands 12 made of aluminum or aluminum alloy, of which an elongation rate is, for example, 2% or more. A diameter of the metal strand 12 is, for example, 0.32 mm. The twisting when the metal strands 12 are intertwined and configure the aggregated twisted wire 11 is the primary twisting.

In the embodiment, the composite twisted wire conductor 10 is configured of a three-layered structure including a center aggregated twisted wire 11a, a first layer composite twisted wire 11b, and a second layer composite twisted wire 11c. The center aggregated twisted wire 11a is the aggregated twisted wire 11 which is positioned on the most center side of the section. The first layer composite twisted wire 11b is formed by twisting the plurality of aggregated twisted wires 11 provided to overlap the periphery of the center aggregated twisted wire 11a. The second layer composite twisted wire 11c is formed by twisting the plurality of aggregated twisted wires 11 provided to overlap the periphery of the first layer composite twisted wire 11b. Here, the twisting when forming the first and second layer composite twisted wires 11b and 11c from the plurality of aggregated twisted wires 11 is the main twisting.

In the embodiment, for example, the first layer composite twisted wire 11b is configured by mainly twisting 6 aggregated twisted wires 11, and the second layer composite twisted wire 11c is configured by mainly twisting 12 aggregated twisted wires 11. However, the number of aggregated twisted wires 11 is not limited to the description above, and for example, as illustrated in FIG. 1, the first layer composite twisted wire 11b may be configured by mainly twisting 8 aggregated twisted wires 11. Furthermore, the number of second layer composite twisted wires 11c is also not limited to 12, and may be 18 or the like.

Additionally, in the embodiment, the composite twisted wire conductor 10 is configured by the twisting as follows. Table 1 is a view illustrating a twisting direction of the composite twisted wire conductor 10 according to the embodiment.

TABLE 1

| | | CONDUCTOR | | | | | |
|---|---|---|---|---|---|---|---|
| | | | TWISTING DIRECTION | | | | |
| | | | CENTER | | | SECOND | |
| | | | AGGREGATED | FIRST COMPOSITE | | COMPOSITE | |
| | | | TWISTED WIRE | TWISTED WIRE | | TWISTED WIRE | |
| | MATERIAL OF | TWISTING | PRIMARY | PRIMARY | MAIN | PRIMARY | MAIN |
| | CONDUCTOR | METHOD | TWISTING | TWISTING | TWISTING | TWISTING | TWISTING |
| FIRST | ALUMINUM OR | COMPOSITE | S | Z | Z | S | S |
| EXAMPLE | ALUMINUM ALLOY | TWISTING | | | | | |
| SECOND | ALUMINUM OR | COMPOSITE | Z | S | S | Z | Z |
| EXAMPLE | ALUMINUM ALLOY | TWISTING | | | | | |

As illustrated in Table 1, in the first example (example in FIG. 2A), the center aggregated twisted wire 11a is S-twisted. In addition, the second layer composite twisted wire 11c is also S-twisted by both of the primary twisting and the main twisting. Meanwhile, the first layer composite twisted wire 11b is Z-twisted by both of the primary twisting and the main twisting. In other words, among the three layers, the first and the third layers are primarily and mainly twisted in the same direction (first direction), and the second layer is primarily and mainly twisted in the direction (second direction) opposite to the first direction.

In addition, as described in the second example (example of FIG. 2B), the center aggregated twisted wire 11a and the second layer composite twisted wire 11c may be Z-twisted by both of the primary twisting and the main twisting, and the first layer composite twisted wire 11b may be S-twisted by both of the primary twisting and the main twisting.

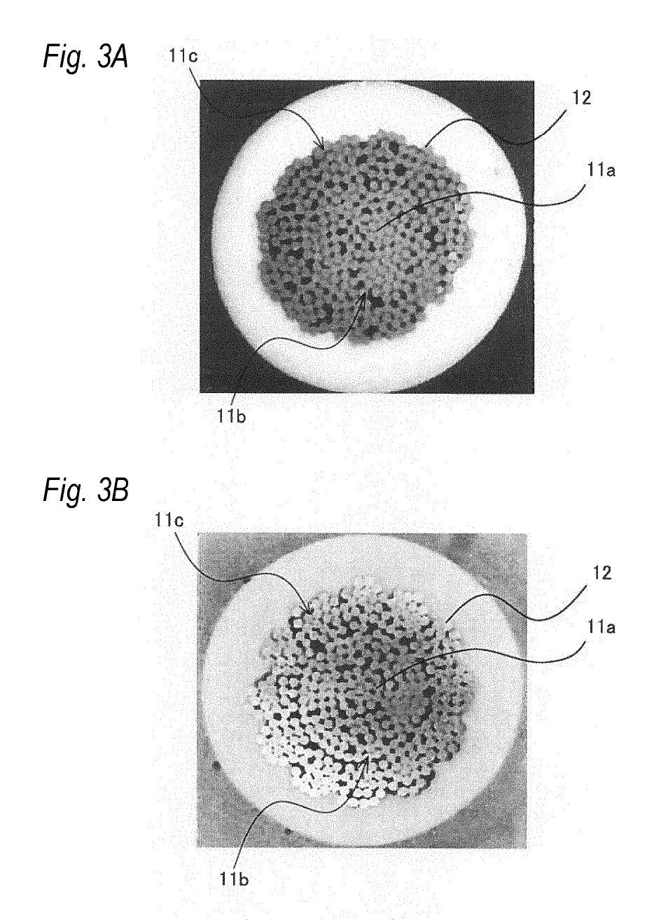

By such a configuration, an insulated wire 1 according to the embodiment is made such that the composite twisted wire conductor 10 is unlikely to have an elliptical shape. FIGS. 3A and 3B are views illustrating a section of an insulated wire. FIG. 3A illustrates a section of the insulated wire when all of the twisting directions are the same direction, and FIG. 3B illustrates a section of the insulated wire according to the first example illustrated in FIGS. 2A and 2B.

As illustrated in FIG. 3A, in a case where all of the twisting directions of the primary twisting and the main twisting of the center aggregated twisted wire 11a, first layer composite twisted wire 11b, and the second layer composite twisted wire 11c are the same direction, the metal strand 12 is likely to enter between the other metal strands 12, and the flat shape of the conductor after the intertwining is raised.

Meanwhile, in the embodiment, the metal strand 12 which configures the center aggregated twisted wire 11a and the metal strand 12 which configures the aggregated twisted wire 11 of the second layer composite twisted wire 11c are unlikely to enter between the metal strands 12 of the first layer composite twisted wire 11b. As a result, as illustrated in FIG. 3B, the flat shape of the conductor after the intertwining is unlikely to be raised, and can be close to a complete circle in sectional view.

Furthermore, in the embodiment, it is preferable that a primary twisting pitch of the aggregated twisted wire 11 that configures the first layer composite twisted wire 11b is greater than primary twisting pitches of the aggregated twisted wires 11 that configure the center aggregated twisted wire 11a and the second layer composite twisted wire 11c.

Accordingly, by reducing the primary twisting pitch of the second layer composite twisted wire 11c to be particularly smaller than the primary twisting pitch of the first layer composite twisted wire 11b, it is possible to fasten the entire conductor from the outside, and to easily hold a round shape. Therefore, it is possible to make it difficult to generate the flat shape of the conductor.

Additionally, in the embodiment, it is preferable that the primary twisting pitch of the aggregated twisted wires 11 that configure the center aggregated twisted wire 11a and the second layer composite twisted wire 11c are substantially the same as each other.

Accordingly, (as a countermeasure for flat shape, the aggregated twisted wire 11 which configures the first layer composite twisted wire 11b is twisted in a different direction, but), since the center aggregated twisted wire 11a and the second layer composite twisted wire 11c have the same primary twisting direction, by setting the pitch to be substantially the same, the aggregated twisted wire having the same primary twisting may be manufactured, and manufacturing efficiency can be improved.

Next, an example and a comparative example will be described. Table 2-1 and 2-2 show specifications of an insulated wire according to an example and a comparative example of the present invention in detail.

TABLE 2-1

| | CONDUCTOR | | | | | |
|---|---|---|---|---|---|---|
| | | | | CALCULATED | OUTER | |
| | | | | COROSS | DIAMETER OF | |
| | | MATERIAL OF | CONFIGURATION | SECTION | CONDUCTOR | TWISTING |
| | SIZE | CONDUCTOR | [NUMBER/mm] | [mm2] | [mm] | METHOD |
| EXAMPLE | 30 sq | ALUMINUM | 19/19/0.32 | 29.03 | APPROXIMATELY | COMPOSITE |
| | | ALLOY | | | 7.70 | TWISTING |
| COMPARATIVE | 30 sq | ALUMINUM | 19/19/0.32 | 29.03 | APPROXIMATELY | COMPOSITE |
| EXAMPLE | | ALLOY | | | 7.70 | TWISTING |

| | CONDUCTOR | | | | |
|---|---|---|---|---|---|
| | TWISTING DIRECTION AND TWISTING PITCH | | | | |
| | CENTER | | | | |
| | AGGREGATED | | | | |
| | TWISTED | FIRST COMPOSITE | | SECOND COMPOSITE | |
| | WIRE | TWISTED WIRE | | TWISTED WIRE | |
| | PRIMARY | PRIMARY | MAIN | PRIMARY | MAIN |
| | TWISTING | TWISTING | TWISTING | TWISTING | TWISTING |
| EXAMPLE | S | Z | Z | S | S |
| | 35-45 mm | 50-60 mm | 55-70 mm | 35-45 mm | 85-100 mm |
| COMPARATIVE | Z | S | S | Z | Z |
| EXAMPLE | 35-45 mm | 50-60 mm | 55-70 mm | 35-45 mm | 85-100 mm |

TABLE 2-2

| | X DIMENSION OF | Y DIMENSION OF | | |
|---|---|---|---|---|
| | OUTER DIAMETER OF | OUTER DIAMETER OF | FLATNESS | |
| | CONDUCTOR (mm) | CONDUCTOR (mm) | (%) | STATE OF |
| | [MINIMUM VALUE] | [MAXIMUM VALUE] | (X/Y)*100 | CONDUCTOR |
| EXAMPLE | 7.52 | 7.66 | 98.2 | EXELLENT |
| COMPARATIVE | 7.46 | 8.08 | 92.3 | ELLIPSE |
| EXAMPLE | | | | |

As shown in Tables 2-1 and 2-2, in both of the example and the comparative example, an aluminum alloy having a diameter of 0.32 mm is used as a metal strand. In addition, the aggregated twisted wire uses only 19 of the metal strands, and is primarily twisted. Among these, in the center aggregated twisted wire, the twisting pitch is 35 mm to 45 mm. In the aggregated twisted wire that configures the first composite twisted wire, the twisting pitch is 50 mm to 60 mm. In the first composite twisted wire, only 6 of the aggregated twisted wires are used, and the main twisting is performed such that the twisting pitch becomes 55 mm to 70 mm. Furthermore, in the aggregated twisted wire that configures the second composite twisted wire, the twisting pitch is 35 mm to 45 mm. In the second composite twisted wire, only 12 of the aggregated twisted wires are used, and the main twisting is performed such that the twisting pitch is 85 mm to 100 mm.

In addition, in the example, the primary twisting direction of the center aggregated twisted wire, and the primary twisting and the main twisting directions of the second composite twisted wire, are S directions, and the primary twisting and the main twisting directions of the first composite twisted wire, are Z directions. In the comparative example, all of the twisting directions are the S directions.

With respect to the composite twisted wire conductor according to the example and the comparative example which is obtained as described above, a coating portion is provided by extrusion molding, and the minimum value X and the maximum value Y are measured with respect to a dimension of an external shape of the composite twisted wire conductor in a sectional view. In addition, flatness is calculated from an equation of flatness (%)=X/Y×100.

As shown in Tables 2-1 and 2-2, the flatness of the insulated wire according to the example is 98.2%, and a result which is 95% or more is achieved. In other words, in the insulated wire according to the example, the composite twisted wire conductor is close to a complete circle, and an excellent result is achieved.

Meanwhile, the flatness of the insulated wire according to the comparative example is 92.3%, and a result which is lower than 95% is achieved. In other words, in the insulated wire according to the comparative example, the composite twisted wire conductor becomes elliptical, and it cannot be said that an excellent result is achieved.

In this manner, according to the composite twisted wire conductor 10 of the embodiment, while the center aggregated twisted wire 11a is primarily twisted in the first direction and the second layer composite twisted wire 11c is primarily and mainly twisted in the first direction, the first layer composite twisted wire 11b is primarily and mainly twisted in the second direction opposite to the first direction. Therefore, the metal strand 12 that configures the center aggregated twisted wire 11a and the metal strand 12 that configures the aggregated twisted wire of the second layer composite twisted wire 11c are unlikely to enter between the metal strands 12 of the first layer composite twisted wire 11b. Accordingly, the flat shape of the conductor after the intertwining is unlikely to be raised, and the shape is unlikely to become an elliptical shape in a sectional view. Therefore, it is possible to provide the composite twisted wire conductor 10 that can improve flatness and can easily ensure the minimum thickness.

In addition, by reducing the primary twisting pitch of the second layer composite twisted wire 11c to be particularly smaller than the primary twisting pitch of the first layer composite twisted wire 11b, it is possible to fasten the entire conductor from the outside, and to easily hold a round shape. Therefore, it is possible to make it difficult to generate the flat shape of the conductor.

In addition, (as a countermeasure for flat shape, the aggregated twisted wire 11 which configures the first layer composite twisted wire 11b is twisted in a different direction, but), since the center aggregated twisted wire 11a and the second layer composite twisted wire 11c have the same primary twisting direction, by setting the pitch to be substantially the same, the aggregated twisted wire having the same primary twisting may be manufactured, and manufacturing efficiency can be improved.

Furthermore, according to the insulated wire 1 of the embodiment, since the flatness of the composite twisted wire conductor 10 is improved, it is possible to provide the insulated wire 1 that achieves uniform thickness of the coating portion 20, and is likely to ensure the minimum thickness.

Above, the present invention is described based on the embodiment, but the present invention is not limited to the embodiment, and may be changed within a range that does not depart from the idea of the present invention.

For example, the composite twisted wire conductor 10 according to the embodiment has a three-layered structure, but not being limited thereto, the composite twisted wire conductor 10 may have a structure having four or more layers. In this case, it is preferable that the fourth layer is primarily and mainly twisted in a direction opposite to the primary twisting and main twisting directions of the second layer composite twisted wire 11c which is the third layer. Furthermore, in a case of the fifth or the next following layers, similarly, it is preferable that the layers are primarily and mainly twisted in a direction opposite to the primary twisting and main twisting directions of a layer which is one layer below the corresponding layer.

Additionally, in the embodiment, all of the number of metal strands 12 that configure each of the aggregated twisted wires 11 are the same, but not being limited thereto, the number of metal strands 12 that configure each of the aggregated twisted wires 11 may partially vary. Additionally, a diameter or a material of the metal strand 12 to be used may partially vary.

In view of the above, according to an aspect of the invention, there is provided the corrugated tube and the wire harness described as (i) to (iv) below.

(i) A composite twisted wire conductor (10) having a plurality of aggregated twisted wires (11) formed by primarily twisting a plurality of conductive metal strands (12), the conductor (10) comprising:

a center aggregated twisted wire (11a) which is an aggregated twisted wire positioned on the most center side of a section;

a first layer composite twisted wire (11b) formed by mainly twisting a plurality of aggregated twisted wires provided to overlap a periphery of the center aggregated twisted wire (11a); and

a second layer composite twisted wire (11c) formed by mainly twisting a plurality of aggregated twisted wires provided to overlap a periphery of the first layer composite twisted wire (11b),

wherein the center aggregated twisted wire (11a) is primarily twisted in a first direction,

wherein the first layer composite twisted wire (11b) is primarily and mainly twisted in a second direction opposite to the first direction, and

wherein the second layer composite twisted wire 811c) is primarily and mainly twisted in the first direction.

(ii) The composite twisted wire conductor (10) according to the above (i), wherein

a primary twisting pitch of the aggregated twisted wire that configures the first layer composite twisted wire (11b) is greater than a primary twisting pitch of the aggregated twisted wire that configures the second layer composite twisted wire (11c).

(iii) The composite twisted wire conductor (10) according to the above (iii), wherein

the primary twisting pitches of the aggregated twisted wires that configure the center aggregated twisted wire (11a) and the second layer composite twisted wire (11c) are substantially the same as each other.

(iv) An insulated wire (1) comprising:

the composite twisted wire conductor (10) according to the above (i); and

an insulating coating portion (20) provided in the composite twisted wire conductor (10).

According to the present invention, it is possible to provide a composite twisted wire conductor that can improve flatness and can easily ensure the minimum thickness, and an insulated wire provided with the same.

What is claimed is:

1. A composite twisted wire conductor having a plurality of aggregated twisted wires formed by primarily twisting a plurality of conductive metal strands, the conductor comprising:
a center aggregated twisted wire which is an aggregated twisted wire positioned on the most center side of a section;
a first layer composite twisted wire formed by mainly twisting a plurality of aggregated twisted wires provided to overlap a periphery of the center aggregated twisted wire; and
a second layer composite twisted wire formed by mainly twisting a plurality of aggregated twisted wires provided to overlap a periphery of the first layer composite twisted wire,
wherein the center aggregated twisted wire is primarily twisted in a first direction,
wherein the first layer composite twisted wire is primarily and mainly twisted in a second direction opposite to the first direction, and
wherein the second layer composite twisted wire is primarily and mainly twisted in the first direction.

2. The composite twisted wire conductor according to claim 1, wherein
a primary twisting pitch of the aggregated twisted wire that configures the first layer composite twisted wire is greater than a primary twisting pitch of the aggregated twisted wire that configures the second layer composite twisted wire.

3. The composite twisted wire conductor according to claim 2, wherein
the primary twisting pitches of the aggregated twisted wires that configure the center aggregated twisted wire and the second layer composite twisted wire are substantially the same as each other.

4. An insulated wire comprising:
the composite twisted wire conductor according to claim 1; and
an insulating coating portion provided in the composite twisted wire conductor.
